(19) United States
(12) Patent Application Publication
(10) Pub. No.: US 2018/0170318 A1
(43) Pub. Date: Jun. 21, 2018

(54) Operating Fluid Storage System with Identification of the Reservoir Concerned in the Case of a Filling Need

(71) Applicant: Röchling Automotive SE & Co. KG, Mannheim (DE)

(72) Inventors: Walter Kral, Sarntal (IT); Christoph Ganthaler, Naturns (IT); Claudio Nava, Ambivere (BG) (IT); Michael Purps, Wachenheim an der Weinstraße (DE)

(73) Assignee: Röchling Automotive SE & Co. KG

(21) Appl. No.: 15/839,038

(22) Filed: Dec. 12, 2017

(30) Foreign Application Priority Data
Dec. 19, 2016 (DE) 10 2016 225 398.0

(51) Int. Cl. B60S 1/50; G01F 23/00; G01F 23/24

(52) U.S. Cl. CPC B60S 1/50; G01F 23/0015; B60K 15/03006; G01F 23/242; G01F 23/0069

(57) ABSTRACT

An operating fluid storage system for a motor vehicle having a reservoir with a filling opening and a closure cover which closes the filling opening and which can be removed from said filling opening to release the filling opening, and with at least one operating fluid outlet opening, to which an operating fluid conveyor line can be connected, for the output of operating fluid to a consumer, the system having a need sensor assembly and an output device, the need sensor assembly determines a filling need of the reservoir and outputs a corresponding need signal to the output device which acoustically, visually and/or haptically outputs a signal indicating the filling need; on the reservoir, an identification device is provided, which can be switched between at least two functional states and which is connected to the need sensor assembly via signal transmission, and which, when the need sensor assembly determines a filling need of the reservoir, is actuated by a corresponding need signal of the need sensor assembly to change the functional state thereof from a first functional state to a second functional state different therefrom.

The present invention relates to an operating fluid storage system for a motor vehicle, comprising a reservoir with a filling opening and a closure cover which closes the filling opening and which can be removed from said filling opening to release the filling opening, and with at least one operating fluid outlet opening, to which an operating fluid conveyor line can be or is connected, for the output of operating fluid to a consumer, wherein the operating fluid storage system moreover comprises a need sensor assembly and an output device, wherein the need sensor assembly determines a filling need of the reservoir and outputs a corresponding need signal to the output device which acoustically and/or visually and/or haptically outputs a signal indicating the filling need.

### BACKGROUND OF THE INVENTION

Such operating fluid storage systems are known, for example, from motor vehicles, such as those with the fuel tank as reservoir. If the residual filling quantity in the fuel tank falls below a predetermined lower limit, then this information is acquired by the need sensor assembly which is usually provided motor vehicles, and is output by a sound signal or a light signal on the dashboard to the vehicle driver. If a vehicle comprises a multifunction display device, then the filling need of the fuel tank is usually also displayed there.

The same applies similarly to the coolant reservoir in the motor vehicle, in which coolant for cooling the combustion engine machine is stored. The coolant reservoir is also referred to as “equalizing reservoir” in the applicable technique.

The filling level of reservoirs for window cleaning fluid is also monitored by sensor in some motor vehicles, and the filling need is displayed visually and/or acoustically in the vehicle interior.

The number now reached of the different reservoirs arranged immediately next to one another or in the same functional receiving space, for example, in the engine compartment, is frequently problematic in motor vehicles. Thus, the coolant equalizing reservoir, the reservoir for window cleaning fluid, a reservoir for the operating fluid in a motor vehicle air conditioning system, etc., are arranged in the engine compartment and can be readily distinguished from one another only to a limited extent. Frequently, the closure covers of these reservoirs are provided with symbols which, in some cases, are not even of contrasting color with respect to the background, and even if they are, the symbol provided is frequently no longer visible due to operation-caused soiling.

Therefore, it can happen that a vehicle driver, prompted by the display of a filling need on the dashboard, opens the engine hood and fills a reservoir in the engine compartment with the presumably correct operating fluid and, in the process, unfortunately services the incorrect reservoir. The consequences of this are all the more serious given the use of increasingly specialized fluids in vehicles for the individual consumers of operating fluids. Thus, as a rule, the coolant equalizing reservoir cannot simply be filled with water that could also be used as window cleaning water. As coolant, it is increasingly necessary to use only special operating fluids approved by the respective manufacturer, so that a mix-up of reservoirs when refilling can have disadvantageous effects on the operating safety and the operating capacity of the respective vehicle.

From DE 10 2009 038 471 A1, numerous solutions are known for preventing incorrect filling of vehicle reservoirs. Their disadvantage: they are all impractical and not suitable for daily use.

Thus, DE 10 2009 038 471 A1 cites, as prior art for the invention described therein, a shape- and/or dimension-based adaptation of container openings and nozzles. During fuel filling, this can be helpful, to the extent that standardized filling opening shapes and standardized nozzles are used at filling stations. For the other reservoirs, which receive other operating fluids other than fuels, nozzles are not used as a rule, but rather the operating fluid is poured in the form of a free stream through the filling opening into the reservoir.

DE 10 2009 038 471 A1 moreover recommends providing RFID transmitters in the respective commercially available reservoirs for operating fluid and arranging corresponding receivers on the vehicle reservoirs, so that a reservoir on the motor vehicle can only be opened if a container with the appropriate operating fluids approaches said reservoir for the filling.

However, on the one hand, vehicle manufacturers have not provided their reservoirs with corresponding receivers, and, on the other hand, the commercially available reservoirs are not provided with corresponding identifying transmitters. So far, there has not even been an agreement on a common standard for car manufacturers.

### SUMMARY OF THE INVENTION

Therefore, the aim of the present invention is to develop the operating fluid storage system mentioned at the start with a view to general suitability in such a manner that the risk of incorrect filling can be reduced considerably or even excluded.

The present invention achieves this aim and others by means of an operating fluid storage system of the type in question, in which, on the reservoir, an identification device which can be switched between at least two functional states is provided, identification device which is connected to the need sensor assembly by signal transmission and which, when the need sensor assembly determines a filling need of the reservoir, is actuated by a corresponding need signal of the need sensor assembly to change the functional state thereof from a first functional state to a second functional state different therefrom.

Here, the present invention is based on the largely applicable assumption that most incorrect filling operations on motor vehicles result from the fact that the vehicle driver who is informed about a filling need in fact prepares the appropriate operating fluid for the notified filling need, but fills it by mistake into the incorrect reservoir. By means of the identification device provided on the reservoir, it is possible, by change in the functional state of the identification device, to identify the reservoir to which the actually detected filling need applies, from several reservoirs which are arranged in spatial proximity to one another and which can therefore easily be mixed up. Thus, for the refilling vehicle driver or also for any other person, the reservoir that needs to be refilled can be identified uniquely from a plurality of reservoirs.

According to an advantageous development of the present invention, the identification device can comprise at least one lamp, which has a different lighting state in the first functional state than in the second functional state. For example, the lamp can be switched off in the first functional state and switched on in the second functional state. Or, the lamp can emit red light in the first functional state and green light in the second functional state. To the extent that the identification device has a plurality of lamps on each reservoir, the identification device in the second functional state—in contrast to the first functional state—can generate moving points of light such as, for example, points of light converging on the filling opening, for example, in the shape of arrow tips and the like.

Very generally, the above-discussed development of the present invention can therefore be described by the fact that the lighting states of the two functional states differ with regard to the brightness and/or the color of the lamp.

Alternatively or additionally to the mentioned at least one lamp, the reliability of the prevention of incorrect filling can be increased in that the identification device has at least one locking element which, in the first functional state, locks the closure cover in a closed position closing the filling opening, and which, in the second functional state, releases the closure cover for the adjustment into an open position releasing the filling opening. The vehicle reservoir affected by the filling need is then identified by the identification device in that the closure cover thereof is the only one that can be removed from the filling opening, because it is the only one that is unlocked by the locking means provided.

The locking means can have a bolt which is movable between a locking position and a release position, and which engages, in the locking position, with positive locking connection in a corresponding locking recess on the closure cover.

The identification device can be provided on the container body of the reservoir, preferably in the vicinity of the filling opening, and/or it can be provided on the closure cover. Preferably, the identification device is provided on the container body, since it is easier to implement an energy supply of the identification device there than on the closure cover which can be removed from the filling opening, although the latter possibility should not be excluded.

Additionally or alternatively to the locking means, the identification device can have an adjustment actuator, by means of which the closure cover can be adjusted to the open position releasing the filling opening. Then, upon transition of the identification device from the first functional state into the second functional state, the filling opening is already ready for filling by the person performing the filling. To make it easier to locate the closure cover which has been adjusted to the open position, the reservoir can have, in addition, a lamp as part of the identification device, as described above.

In the first functional state, the adjustment actuator can hold the closure cover in the closed position thereof, closing the filling opening, so that the adjustment actuator also acts as locking means in this case, since the force needed to remove the closure cover from the filling opening is increased considerably due to the action of the adjustment actuator in the first functional state of the identification device.

In a simple case, the need sensor assembly can have only one sensor which, if a filling level of the reservoir drops below a predetermined threshold filling level and upon acquisition of this undershooting of the filling level, an activation signal is output to the output device and to the identification device. Such a need sensor assembly only provides digital information on whether or not there is a filling need.

An information content beyond this scope can then be obtained if the need sensor assembly has a filling quantity sensor designed for the acquisition of an acquisition value representing the filling quantity present in the reservoir, and has a control device which is connected to the filing quantity sensor by signal transmission for the transmission of an acquisition signal representing the acquisition value, wherein the control device is designed to compare the acquisition value acquired by the filling quantity sensor with a predetermined threshold value and to output the need signal depending on the comparison result. Then, with the help of the need sensor assembly, not only the filling need but also information on the filling quantity of operating fluid present in the reservoir, as known, for example, from a gas gauge in vehicles, can be determined. The control device can then verify the acquisition signal which has been output by the filling quantity sensor and which represents the filling quantity, in order to determine whether predetermined threshold values have been exceeded or not reached, and can display or use the information contained in the acquisition signal on the output device and on the identification device.

Here, “filling quantity sensor” very generally refers to a sensor which acquires any type of information on the operating fluid quantity present in the reservoir. This can in fact be an acquisition signal representing the filling quantity as volume variable, but it can also be a filling level signal which also represents the filling quantity. Although there is a clear connection between filling level and filling quantity, this connection is nonlinear if the shape of the reservoir is three-dimensionally irregular due to the available installation space, so that the actual filling quantity as a volume or weight variable can be derived from an acquired filling level only by complex calculation operations. Nonetheless, a filling level sensor is also a filling quantity sensor in the sense of the present application.

Depending on the operating fluid for which a filling need exists, it can be desirable not to open the reservoir concerned immediately, since the residual amount of operating fluid present therein is so hot or the reservoir is under a sufficiently high pressure that there is a risk of injury for the person opening the reservoir. The risk of injury can be decreased or eliminated in that the need sensor assembly has at least one safety sensor which is connected to the control device by signal transmission and which, for the acquisition of at least one safety-relevant variable for the filling of the reservoir, acquires, for example, reservoir inner pressure and/or reservoir temperature and/or temperature of the residual filling quantity of operating fluid in the reservoir, and outputs a corresponding safety acquisition signal to the control device, wherein the control device is designed so as to output the need signal or a safety signal authorizing the removal of the closure cover from the filling opening to the identification device only if the safety acquisition signal has a predetermined signal value or is in a predetermined signal value range.

The separation of need signal and safety signal is relevant if, for example, due to the activation of a lamp, the reservoir affected by the filling need can in fact be clearly identified, and thus the identification device has achieved the aim assigned to it according to the invention, which is to say that, due to an absent yet needed safety signal, a locking means keeps the closure cover in the closed position closing the filling opening thereof, in spite of the existing filling need, and thus secures it against an adjustment into the open position thereof. In this case, on the reservoir, both the at least one lamp and also the locking means can be provided, wherein the adjustment thereof between different operating positions, can occur temporally separately from one another in spite of an acquired filling need. In order to reliably regulate this separation for an operating person, it is appropriate and helpful to use a safety signal, in addition to the need signal.

Moreover, application cases are conceivable in which the identification device should not yet be switched to the second functional state, in spite of an acquired filling need. For example, if the vehicle driver, in spite of having been notified of the filling need on the dashboard, is unable to perform a filling due to lack of opportunity, it makes no sense to operate a lamp and/or a locking means and waste energy thereby. Moreover, in particular if a displayed filling need is at first ignored, the case can occur in which a filling need is acquired for several operating fluids and the different reservoirs thereof, which, in the case of simultaneous activation of several in each case different identification devices, results again in a risk of confusion between the reservoirs, which is precisely what is to be avoided.

In order to avoid unnecessary energy waste and/or an unwanted risk of confusion, according to an advantageous development of the present invention, the operating fluid storage system can have an input device for the signal input, for example, in the form of a pressure button or a surface provided for this purpose on a touch-sensitive screen. The input device is connected directly or indirectly to the need sensor assembly by signal transmission. If the need sensor assembly has the above-mentioned control device, the input device is preferably connected to the control device. If the need sensor assembly has only one sensor outputting an activation signal, the input device is coupled preferably directly to the sensor. The need sensor assembly is then designed to output the need signal only after a signal input on the input device has occurred beforehand. As a result, an operating person is provided with the possibility of acknowledging the filling need displayed for said person via the output device, and of indicating thereby that he/she would like to perform the required filling within a predetermined time span following the acknowledgment, so that the need signal can then be triggered for the predetermined time span, with the resulting consequences of a switching of the functional state of the identification device. This is only an embodiment example for the use of an input device. The mentioned input device should not be understood to be limited to this application example.

The present invention further relates to a motor vehicle with an operating fluid storage system designed and developed as described above, wherein the control device of the operating fluid storage system is implemented as a motor vehicle control device of the motor vehicle, for example, as the on-board computer. Preferably, the motor vehicle has a plurality of operating fluid storage systems which are designed or developed as described above, so that the motor vehicle has a plurality of reservoirs which in principle can be confused with one another. Via the implementation of the control device of the operating fluid storage system as the on-board computer and generally as a motor vehicle control device, a control device can be used for several operating fluid storage systems.

These and other aims, objects, aspects, features, refinements and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which forms a part hereof and wherein:

FIG. 1 shows an embodiment according to the invention of an operating fluid storage system of the present application.

### DESCRIPTION OF PREFERRED EMBODIMENTS

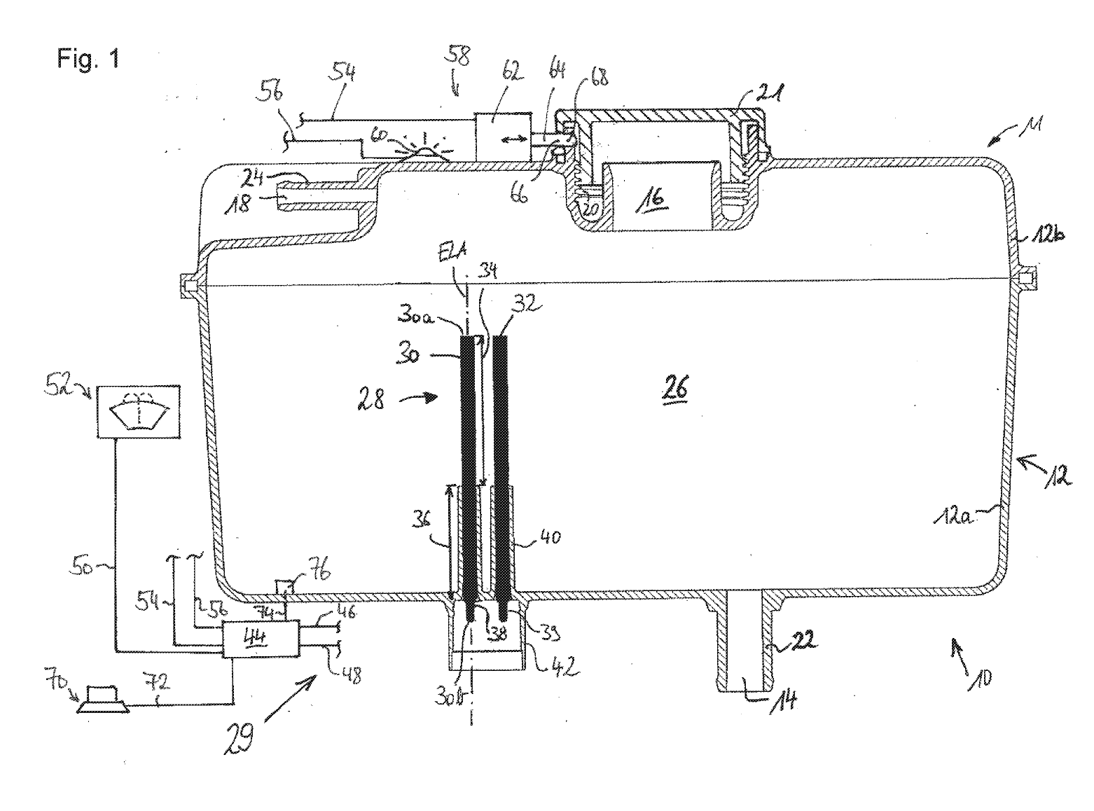

Referring now to the drawings wherein the showings are for the purpose of illustrating preferred and alternative embodiments of the invention only and not for the purpose of limiting the same, FIG. 1 shows a first embodiment of an operating fluid storage system according to the invention that is marked overall with 10. In the example represented in FIG. 1, the operating fluid storage system comprises a plastic container 11, for example, a spray water tank for a window washing device of a car. The plastic container 11 comprises a container body 12 consisting of a lower shell 12a and an upper shell 12b sealingly connected thereto. The container body 12 has an operating fluid outlet opening 14 and a filling opening 16. Moreover, an additional opening 18 is provided, which can be used, for example, for ventilation and aeration and thus for pressure compensation.

The filling opening 16 is provided with a threading 20, by means of which a removable closure cover 21 can be screwed on detachably, in order to close the filling opening 16. Instead of the threading 20, another closure mechanism can also be provided, such as a bayonet closure or a simple catch mechanism. The remaining openings 14 and 18 are designed as hose insertion ports 22 and 24. An electrode assembly 28 of a need sensor assembly 29 with two electrodes 30 and 32 made of an electrically conductive plastic extends into the internal space 26 of the container body 12. The electrodes 30 and 32 are designed identically, wherefore it is sufficient below to describe only the electrode 30 on the left in FIG. 1, which is also representative of the electrode 32.

In the example shown in FIG. 1, the electrode 30 extends in the shape of a rod along an electrode longitudinal axis ELA. The electrode 30 includes an acquisition section 34 extending from the longitudinal end 30a thereof, located in the internal space 26 of the container body 12, slightly past the longitudinal center of the electrode 30. In the direction of the electrode longitudinal axis ELA, said acquisition section is adjoined by a connecting section 36, along which the electrode 30 is surrounded by material of the lower shell 12a of the container body 12 in the shape of a sleeve. The longitudinal end area 38 which adjoins the connecting section 36 in longitudinal direction of the electrode longitudinal axis ELA and extends to the longitudinal end 30b of the electrode 30, located outside of the container body 12, is designed as closure section, onto which an electrical contact at the end of an electrical line can be plugged for contacting the electrode 30.

The electrodes 30 and 32 and the lower shell 12a and the upper shell 12b of the container body 12 include the same polymer material. Said polymer material is used unfilled only for the container body 12 and used filled with electrically conductive particles for the electrodes 30 and 32.

Along the connecting sections 36, sleeves 40 molded on the lower shell 12a are connected by bonded connection to the electrodes 30 and 32, thus ensuring a good sealing of the lower shell 12a at the site where it is passed through by the electrodes 30 and 32. In the case of roughly simultaneous production of lower shell 12a and electrode device 28, the bonded connection is produced by a two-component injection molding method which is known per se. By diffusion processes and/or melting processes on electrodes 30 and 32 and sleeves 40 which are still hot after the injection molding process, a sealing connection layer forms between said electrodes and sleeves. However, even if this connection layer is designed not to be completely sealing or not to be sealing at all, the sleeves 40 applied against the surfaces of the electrodes 30 and 32 seal the lower shell 12a against leakage, since, due to the use of the same or at least a compatible thermoplastic polymer material, the electrodes 30 and 32 as well as the lower shell 12a have essentially the same or at least very similar substance properties, in particular thermal expansion coefficients, so that, under thermal load changes, hardly any relative movement jeopardizing the seal occurs between the electrodes 30 and 32 and the sleeves 40.

Via the connector sections 38 and 39 of the electrodes 30 and 32, by means of a plug (not shown) which is plugged into the socket 42 molded integrally on the container body 12, an electrical voltage can be applied to the electrodes 30 and 32, wherein said electrodes then have a different electrical potential. By measuring this electrical resistance between the electrodes 30 and 32 (for example, by measuring the decreasing voltage between said electrodes), a conclusion can be drawn at least regarding the presence of a minimum filling quantity in the container body 12. If the electrodes 30 and 32 are wetted with electrically conductive fluid, then the acquired resistance drops to a finite value.

In addition to the electrode assembly 28, the need sensor assembly 29 includes a control device 44, for example, an on-board computer of a vehicle carrying the above-described storage system 20. The control device 44 can be connected via line assemblies 46 and 48 to the plug, which is not shown, and which, as described above, can be introduced into the socket 42 for the establishment of a conductive connection with the connector sections 38 and 39 of the electrodes 30 and 32. A plug correctly plugged into the socket 42 then transmits the acquisition signals delivered by the electrodes 30 and 32 to the control device 44 which evaluates said signals in a manner known per se, for example, by comparison with one or more threshold values stored in a data storage, in order to determine the filling need of the reservoir 11. For example, the control device 44 can then reach conclusion that there is a filling need if a fluid level in the internal space 26 of the reservoir 11 has decreased to such an extent that it wets only the sleeves 40 and no longer the electrodes 30 and 32. As a result, the ohmic resistance active between the electrodes 30 and 32 increases to a theoretically infinite value.

The control device 44 is connected via a line assembly 50 by signal and/or energy transmission to an output device 52, for example, to a warning lamp 52 in the dashboard.

If, based on the signal delivered by the electrode assembly 28, the control device 44 detects a filling need, then it activates the output device 52 via the line assembly 50, in the present case for the output of a visual signal to the vehicle driver.

The control device 44 is moreover connected via line assemblies 54 and 56 to an identification device 58 on the upper shell 12b of the container body 12 of the reservoir 11.

The identification device 58 is used for the identification of the reservoir 11 with the determined filling need, in a functional space of the motor vehicle, for example, an engine compartment, in which several reservoirs are arranged, which in principle can be confused for one another.

In the represented example, the identification device 58 has a lamp 60, such as a light emitting diode 60, which is connected via the line assembly 56 to the control device 44.

If the need sensor assembly 29 detects a filling need of the reservoir 11, the control device 44 and consequently the need sensor assembly 29 can switch on the lamp 60, which was not switched on before, via the line assembly 56, in order to indicate to a person ready to perform the filling which reservoir 11 has the filling need among the plurality of reservoirs.

In the present embodiment example, the identification device 58 additionally has a locking means 62 which is designed in order to move a bolt 64 between a release position and a locking position shown in FIG. 1. The locking means 62 can move the bolt 64 electromagnetically, electromechanically and/or pneumatically, for example.

In the locking position shown in FIG. 1, the bolt 64 passes through a locking recess 66 in the closure cover 21 as well as a reception recess 68 in the upper tank shell 12b. The closure cover 21 cannot be removed from the filling opening 16, due to the described locking by the locking means 62, without previous movement of the bolt into the release position.

If the need sensor assembly 29 detects a filling need of the reservoir 11, it can, via the line assembly 54, displace the locking means 62 for the locking of the bolt 64 from the locking position shown in FIG. 1 into a release position which no longer passes through the two openings 66 and 68. This too is used for the identification of the reservoir 11 which has a filling need, since, in the case of functionally identical equipment of the reservoirs which are provided in such a manner that they can be confused with one another, only the closure cover 21 of the reservoir 11 for which a filling need was detected can be removed from the filling opening 16. To the extent that the bolt 64 can be seen well from outside, the bolt position itself is also a visual identification signal, since, for example, if the bolt 64 is completely pulled back into a housing of the actuator displacing the bolt, while, in all the other reservoirs provided, the bolt bridges a gap between the actuator housing and the closure cover, the reservoir affected by a filling need is visually detectable in this case as well.

In order to activate the identification device 58 only when an identification of the reservoir 11 with filling need is necessary, for example, because said reservoir is to be filled only at a later time, for example, after reaching a filling station, the need sensor assembly 29 can have an input device 70, for example, a push button, which is connected via a line assembly 72 to the control device 44 of the need sensor assembly 29. In this way, the need sensor assembly 29 can in fact determine a filling need of the reservoir 11 and output said need via the output device 52 to the vehicle driver, but the identification device 58 needs to be activated only if the vehicle driver needs this at all, for example, because the vehicle driver is about to open the functional space with the reservoirs, so that, in fact, the need to recognize and open the reservoir 11 with filling need among the plurality of reservoirs exists only at that time.

Moreover, the control device 44 can be connected via a line assembly 74 to a safety sensor 76 in the interior 26 of the reservoir 11, which measures the operating parameter parameters prevailing in the interior 26 of the reservoir 11, such as pressure and/or temperature and transmits them to the control device 44.

The control device 44 can then be designed to control, independently of an actuation of the input device 70, at least the locking means 62 via the line assembly 54 for the release of the removal of the closure cover 21 from the filling opening 16 only if the sensor signal output by the safety sensor 76 via the line assembly 74 to the control device 44 shows that it is safe to remove the closure cover 21 from the reservoir 11.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-10. (canceled)

11. An operating fluid storage system for a motor vehicle, comprising a reservoir with a filling opening and a closure cover which closes the filling opening and which can be removed from said filling opening to release the filling opening, and with at least one operating fluid outlet opening, to which an associated operating fluid conveyor line can be or is connected, for the output of an associated operating fluid to an associated consumer, wherein the operating fluid storage system moreover comprises a need sensor assembly and an output device, wherein the need sensor assembly determines a filling need of the reservoir and outputs a corresponding output device need signal to the output device which at least one of acoustically, visually and haptically outputs a signal indicating the filling need, the operating fluid storage system further comprising an identification device, which can be switched between two functional states and which is connected to the need sensor assembly via signal transmission, and which, when the need sensor assembly determines the filling need of the reservoir, is actuated by a corresponding identification device need signal of the need sensor assembly to change the functional state of the identification device from a first functional state to a second functional state that is different from the first functional state.

12. The operating fluid storage system according to claim 1, wherein the identification device is provided on the reservoir.

13. The operating fluid storage system according to claim 11, wherein the identification device comprises at least one lamp which, in the first functional state, has a different lighting state than in the second functional state.

14. The operating fluid storage system according to claim 13, wherein the lighting states of the two functional states differ with regard to at least one of brightness and color of the at least one lamp.

15. The operating fluid storage system according to claim 11, wherein the identification device has at least one locking arrangement which, in the first functional state, locks the closure cover in a closed position closing the filling opening, and which, in the second functional state, releases the closure cover for the adjustment into an open position releasing the filling opening.

16. The operating fluid storage system according to claim 15, wherein the identification device has an adjustment actuator, by way of which the closure cover can be adjusted into the open position releasing the filling opening.

17. The operating fluid storage system according to claim 11, wherein the identification device has at least one adjustment actuator which, in the first functional state, holds the closure cover in a closed position closing the filling opening and which, in the second functional state, adjusts the closure cover into an open position releasing the filling opening.

18. The operating fluid storage system according to claim 11, wherein the need sensor assembly has a filling quantity sensor, which is designed for the acquisition of an acquisition value representative of the filling quantity present in the reservoir, and has a control device which, for the transmission of an acquisition signal representing the acquisition value by signal transmission, is connected to the filling quantity sensor, wherein the control device is designed in order to compare the acquisition value acquired by the filling quantity sensor with a predetermined threshold value and to output at least the identification device need signal depending on the comparison result.

19. The operating fluid storage system according to claim 18, wherein the need sensor assembly has at least one safety sensor which is connected via signal transmission to the control device and which acquires at least one safety-relevant variable for the filling of the reservoir and which outputs a corresponding safety acquisition signal to the control device, wherein the control device is designed in order to output to the identification device at least one of the identification device need signal and a safety signal authorizing the removal of the closure cover from the filling opening only when the safety acquisition signal has a predetermined signal value or is in a predetermined signal value range.

20. The operating fluid storage system according to claim 19, wherein the at least one safety-relevant variable for the filling of the reservoir includes at least one of a reservoir inner pressure, a reservoir temperature and a temperature of a residual filling quantity of the associated operating fluid in the reservoir.

21. The operating fluid storage system according to claim 11, wherein, for a signal input, the operating fluid storage system has an input device connected via signal transmission to the need sensor assembly for the transmission of an input signal by signal transmission, and the need sensor assembly is designed to output the identification device need signal only after the signal input on the input device has occurred.

22. The operating fluid storage system according to claim 18, wherein, for a signal input, the operating fluid storage system has an input device connected via signal transmission to the control device of the need sensor assembly for the transmission of an input signal by signal transmission, and the need sensor assembly is designed to output the identification device need signal only after the signal input on the input device has occurred.

23. A motor vehicle with an operating fluid storage system according claim 18, wherein the control device of the operating fluid storage system is implemented as a motor vehicle control device of the motor vehicle.
